(19) United States
(12) Patent Application Publication
(10) Pub. No.: US 2009/0297418 A1
(43) Pub. Date: Dec. 3, 2009

(54) Composite Catalyst Materials And Method For The Selective Reduction Of Nitrogen Oxides

(75) Inventor: Wei Liu, Richland, WA (US)

Correspondence Address: Douglas McKinley, PO Box 202, Richland, WA, 99352, US

(73) Assignee: BATTELLE MEMORIAL INSTITUTE, Richland, WA (US)

(21) Appl. No.: 12/473,577

(22) Filed: May 28, 2009

Related U.S. Application Data
(60) Provisional application No. 61/056,701, filed on May 28, 2008.

(51) Int. Cl. B01D 53/56; B01J 23/10

(52) U.S. Cl. 423/239.1; 502/304; 502/303

(57) ABSTRACT

Composite catalyst materials that may be used to reduce nitrogen oxides to nitrogen gas in the presence of other gasses without significant poisoning of the composite catalyst materials or reaction with the other gasses. The composite catalyst materials are formed of a matrix material comprised of cerium oxide doped with alkaline earth metal oxides, rare earth metal oxides, and combinations thereof wherein the cerium oxide comprises more than 50 atomic percent of the matrix material, and nanoparticles comprising transition metal oxides wherein the transition metal oxides comprise less than 20 atomic percent of the composite catalyst material. The composite catalyst materials may further contain noble metals dispersed in the matrix material.

### CROSS REFERENCE TO RELATED APPLICATIONS

This application claims priority to U.S. Provisional Application Ser. No. 61/056,701, filed May 28, 2008.

### TECHNICAL FIELD

This invention relates to composite catalyst materials for the reduction of nitrogen oxides. More specifically, the invention is a new class of composite catalyst materials that may be used to reduce nitrogen oxides to nitrogen gas in the presence of other gasses, including but not limited to sulfur dioxide, steam, oxygen, and carbon dioxide, without significant poisoning of the composite catalyst materials.

### BACKGROUND OF THE INVENTION

As used herein, the terms “nitrogen oxide” and “nitrogen oxides” includes any molecule of the general form NOₓ. Nitrogen oxide is generated in a variety of combustion processes. Unfortunately, the release of nitrogen oxide into the atmosphere has a variety of harmful environmental consequences. Accordingly, there is a long recognized need for methods and techniques for preventing the release of nitrogen oxides into the atmosphere. One common method is the reduction of nitrogen oxide into benign, nitrogen gas. It has long been recognized that catalysts are useful in the reduction of nitrogen oxide to nitrogen gas, and there have been a number of examples of catalyst materials used to reduce nitrogen oxide to nitrogen gas in the prior art.

For example, in the publication “Cu—Mn mixed oxides for low temperature NO reduction with NH3” M. Kang et al./Catalysis Today 111 (2006) 236-241, the authors report that Cu—Mn mixed oxides prepared by a co-precipitation method accomplishes low temperature NO reduction with NH3 in the presence of excess oxygen. The authors report that when these catalysts contained small amounts of copper, they showed complete NOx conversion in a wide range of reaction temperature from 323 to 473 K, and that the catalyst showed a reversible deactivation due to the presence of water vapor and SO2.

In the publication “Mn—Ce/ZSM5 as a new superior catalyst for NO reduction with NH3” G. Carja et al./Applied Catalysis B: Environmental 73 (2007) 60-64, the authors report that Mn—Ce/ZSM-5 catalyst prepared in an aqueous phase at 423 K exhibits a broad temperature window (517-823 K) for high NO conversions (75-100%) in the process of selective catalytic reduction (SCR) by NH3 even in the presence of H2O and SO2.

While these and other prior art catalysts have been successful in reducing nitrogen oxide to nitrogen gas in a laboratory setting, when reducing nitrogen oxide in the actual effluent of a combustion process, such as a coal fired power plant, numerous other gasses are typically present, including, for example, sulfur dioxide, steam, oxygen, and carbon dioxide. These other gasses have been shown to either poison the catalysts, to promote other undesirable reactions involving these other gasses, or both.

Accordingly, there is a need for new catalysts that can selectively reduce nitrogen oxide to nitrogen gas in the presence of sulfur dioxide, steam, oxygen, and carbon dioxide without becoming poisoned or involving these other gasses in undesired reactions. The present invention fulfills that need.

### SUMMARY OF THE INVENTION

The present invention achieves these and other objectives by providing a composite catalyst material for the reduction of nitrogen oxide. The composite catalyst material of the present invention is formed from a matrix material. The matrix material is formed of cerium oxide doped with alkaline earth metal oxides, rare earth metal oxides, and combinations thereof. The cerium oxide comprises more than 50 atomic percent of the matrix material, The composite catalyst material then combines the matrix material with nanoparticles formed of transition metal oxides. As used herein, “nanoparticles” means particles and/or crystals having a mean average size of less than 5 nm as measured by powder X-ray diffraction. The nanoparticles formed of transition metal oxides comprise less than 20 atomic percent of the composite catalyst material.

Optionally, the composite catalyst material may further contain noble metals dispersed in the matrix material. Preferably, but not meant to be limiting, the cerium oxide is formed as a lattice structure, and the alkaline earth metal oxides, rare earth metal oxides and combinations thereof are contained within the lattice structure of the cerium oxide.

Also preferable, but also not meant to be limiting, the nanoparticles of transition metals oxides are dispersed on the cerium oxide matrix material to form the composite catalyst material. Optionally, if noble metals are used, the noble metals may also be dispersed on the cerium oxide matrix material. Preferably, the surface area of the cerium oxide in the matrix material is greater than 35 square meters per gram.

One preferred embodiment of the present invention utilizes lanthanum oxide as the rare earth metal oxide mixed with cerium oxide in the matrix material. In this embodiment it is preferred that the matrix material is about 5 atomic percentage lanthanum oxide. In this embodiment, manganese oxide is used as the transition metal. In this embodiment, it is preferred that the manganese oxide form less that 20 atomic percentage of composite catalyst material, and it is more preferable that the manganese oxide form less that 10 atomic percentage of composite catalyst material. In this embodiment, it is preferred that the surface area of the cerium oxide in the matrix material is greater than 35 square meters per gram.

As is the case with the present invention generally, this preferred embodiment may further include noble metals dispersed in the matrix material. In this embodiment, it is preferred that the noble metals dispersed in the matrix material comprise less than 0.1 atomic percentage of the composite catalyst material. Preferably, while not meant to be limiting, the noble metals are dispersed on the cerium oxide containing matrix material.

As is the case with the rare earth metal oxides and alkaline earth metal oxides used in the present invention generally, it is preferred in this embodiment that the lanthanum oxide is contained within a lattice structure of the cerium oxide. As is the case with the nanoparticles formed of transition metal oxides used in the present invention generally, it is preferred in this embodiment that the manganese oxide is dispersed on the cerium oxide containing matrix material.

The present invention further provides a method for selectively reducing a nitrogen oxide in a gas stream containing nitrogen oxide, sulfur dioxide, steam, oxygen, and carbon dioxide. The present invention achieves selective reduction by first providing a composite catalyst material. The composite catalyst material has a matrix material that includes cerium oxide doped with alkaline earth metal oxides, rare earth metal oxides, and combinations thereof wherein the cerium oxide comprises more than 50 atomic percent of the matrix material. The composite catalyst material also has nanoparticles formed of transition metal oxides wherein the transition metal oxides comprise less than 20 atomic percent of the composite catalyst material. By contacting the composite catalyst material with the nitrogen oxide in the gas stream, the nitrogen oxide is selectively reduced to nitrogen gas. One advantage of the present invention is that the reduction of nitrogen oxide to nitrogen gas occurs without significant poisoning of the composite catalyst material by the sulfur dioxide, steam, oxygen, and carbon dioxide. Another advantage of the present invention is that the reduction of nitrogen oxide to nitrogen gas may be accomplished at a temperature below 300° C.

While not meant to be limiting, the method of the present invention preferably includes the step of introducing the gas stream containing the nitrogen to a reducing gas prior to the step of contacting the nitrogen oxide in the gas stream to the composite catalyst material. The reducing gas is preferably selected from the group comprising ammonia, urea, carbon monoxide, hydrogen, hydrocarbons, and combinations thereof.

The purpose of the foregoing description is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The description is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. The preceding and following descriptions have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

The following detailed description of the embodiments of the invention will be more readily understood when taken in conjunction with the following drawing, wherein:

FIG. 1 is a schematic illustration of a test apparatus where certain embodiments of the present invention were demonstrated.

FIG. 2 is a graph showing NO breakthrough curves of different ceria composite catalysts (GHSV=45,000 1/h on dry gas basis, reactor tube temperature at 140° C., atmospheric pressure).

FIG. 3 is a graph showing the variation of NO conversion with time on stream (180° C., NH₃/NO=1:1, GHSV=35,000 v/v/h)

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

A series of experiments were undertaken to demonstrate various aspects of the present invention. The first step of these experiments were conducted by fabricating the catalysts. The chemicals used in these experiments were Cu(NO₃)₂.2.5H₂O (Aldrich, ≧98%), Mn(NO₃)₂.xH₂O (Aldrich, 98%), Ce(NO₃)₃.6H₂O (Alfa Aesar, 99.5%), NH₄OH (Fisher), HY (Zeolyst, CBV780, Si/Al=40/1), NH4ZSM-5 (Zeolyst, 1318-02-1, CBV8014, Si/Al=40/1). Zeolite-based catalysts were then prepared by a variety of methods. Preparation by ion-exchange (I.E.) method proceeded by immersing and stirring commercial zeolites Y and ZSM-5 in the 1 M NH₄OH for 4 h. The products were then separated by centrifugation (HERMEL Z200A, 11 min, 6000 rpm), washed three times with deionized water (18.3 MΩ cm) and dried at 120° C. overnight in the furnace (Thermolyne, 47900). The samples were added to an ion exchange solution of metal nitrate. The solutions were stirred at 90° C. for 12 h on a hot plate. After the first ion-exchange, the samples were washed with three repetitions (or two times) of centrifugation and redispersion in deionized water to remove excess solution. The wet samples were dried at 120° C. for 12 h at ramp rate of 1° C./min and calcined at 550° C. for 10 h at ramp rate of 1° C./min. Catalysts were pressed at 10000 LB for 5 s and then crushed and sieved into about 40˜100 mesh. The packing density of 40˜100 mesh catalysts was then measured.

Preparation by the incipient wetness impregnation (IW.I) method began by drying the parent zeolite powder at 120 C in an oven. A solution of the precursor metal nitrate salts was prepared at the targeted concentration level. The solution was added into the powder in a beaker drop by drop, while the powder was shaken continuously to provide uniform wetting. The solution addition was stopped when the catalyst powder was fully wetted. The wetted powder was dried at 120° C. for 2 hours at ramp rate of 1° C./min and followed by calcination at 550° C. for 10 h at ramp rate of 1° C./min. The powder was then pressed at 10000 LB for 5 s and then crushed and sieved into about 40˜100 mesh.

The resulting catalyst was analyzed by JEOL JSM-5900LV Scanning electron microscope (SEM) equipped with an Oxford energy dispersive X-ray analysis (EDS) to observe both particle morphology and to assess the catalyst composition. In order to avoid electrical charging on the samples, the catalyst powder was coated with a layer of carbon coated and grounded.

The catalyst compositions were as shown in Tables 1, 2, and 3 below.

TABLE 1
Zeolite catalysts prepared by ion exchange

| # | Name | wt % | Cu | Mn | Ce | Si | Al | Na |
|---|---|---|---|---|---|---|---|---|
| 011609a | CuCe/ZSM-5 | Zone | 1.59 | 0.00 | 0.00 | 64.23 | 1.28 | 0.00 |
| | | crystal 1 | 1.68 | 0.00 | 0.00 | 58.52 | 1.29 | 0.00 |
| | | crystal 2 | 2.03 | 0.00 | 0.00 | 63.52 | 1.02 | 0.00 |
| 011609b | MnCe/ZSM-5 | Zone | 0.00 | 0.00 | 2.69 | 65.55 | 1.26 | 0.00 |
| | | crystal 1 | 0.00 | 0.00 | 9.22 | 62.13 | 1.14 | 0.00 |
| | | crystal 2 | 0.00 | 0.00 | 1.16 | 57.99 | 1.37 | 0.00 |
| 011609c | CuCe/Y | Zone | 0.00 | 0.00 | 0.00 | 62.03 | 0.00 | 0.00 |
| | | crystal 1 | 1.00 | 0.00 | 7.01 | 61.39 | 2.29 | 0.00 |
| | | crystal 2 | 1.31 | 0.00 | 0.00 | 70.00 | 0.83 | 0.00 |
| 011609d | MnCe/Y | Zone | 0.00 | 0.00 | 1.51 | 65.20 | 0.76 | 0.00 |
| | | crystal 1 | 0.00 | 0.00 | 15.39 | 57.22 | 0.77 | 0.00 |
| | | crystal 2 | 0.00 | 0.00 | 1.43 | 67.77 | 1.53 | 0.00 |

TABLE 2
Zeolite catalysts prepared by impregnation

| # | Name | wt % | Cu | Mn | Ce | Si | Al | Na |
|---|---|---|---|---|---|---|---|---|
| 121508a | CuCe/ZSM-5 | Zone 1 | 1.42 | 0.00 | 10.11 | 57.79 | 1.08 | 0.00 |
| | | Zone 2 | 1.10 | 0.00 | 9.88 | 57.39 | 1.10 | 0.00 |
| | | LS | 1.24 | 0.00 | 7.47 | 49.05 | 1.10 | 0.00 |
| | | crystal | | | | | | |
| 121508b | MnCe/ZSM-5 | Zone 1 | 0.00 | 0.85 | 10.10 | 57.61 | 0.94 | 0.00 |
| | | Zone 2 | 0.00 | 0.62 | 10.94 | 57.50 | 0.99 | 0.00 |
| | | large | 0.00 | 0.84 | 35.17 | 39.97 | 1.94 | 0.00 |
| | | crystal | | | | | | |
| 011209a | CuCe/Y | Zone | 1.90 | 0.00 | 7.37 | 55.51 | 1.09 | 0.00 |
| | | crystal 1 | 1.65 | 0.00 | 9.13 | 52.52 | 0.63 | 0.00 |
| | | crystal 2 | 1.34 | 0.00 | 6.71 | 60.93 | 0.84 | 0.00 |
| 011209b | MnCe/Y | Zone | 0.00 | 1.15 | 14.16 | 53.13 | 0.94 | 0.00 |
| | | crystal 1 | 0.00 | 0.95 | 11.84 | 52.73 | 0.81 | 0.00 |
| | | crystal 2 | 0.00 | 1.44 | 18.07 | 49.46 | 0.77 | 0.00 |

TABLE 3
zeolite catalysts prepared by impregnation

| # | Name | at. % | Fe | Mn | Cu | Ce |
|---|---|---|---|---|---|---|
| 021109a | FeCe/ZSM-5 | zone 1 | 0.88 | | | 1.2 |
| | | zone 2 | 0.93 | | | 1.07 |
| | | zone 3 | 0.72 | | | 0.99 |
| 021109b | FeMnCe/ZSM-5 | zone 1 | 1.24 | 1.54 | | 1.65 |
| | | zone 2 | 1.3 | 1.13 | | 1.73 |
| | | crystal | 0.89 | 0.76 | | 1.17 |
| 021109c | FeMn/ZSM-5 | zone 1 | 1.06 | 0.85 | | |
| | | Crystal | 1.07 | 1.1 | | |
| | | Crystal | 1.22 | 1.49 | | |
| 021109d | CuMnCe/ZSM-5 | zone 1 | | 1.05 | 1.63 | 1.42 |
| | | zone 2 | | 0.85 | 1.43 | 1.23 |
| | | zone 3 | | 1.08 | 1.53 | 1.54 |
| 021109e | FeCe/Y | zone 1 | 0.38 | | | 1.98 |
| | | zone 2 | 0.34 | | | 1.88 |
| | | zone 3 | 0.31 | | | 2.27 |
| 021109f | FeMnCe/Y | zone 1 | 2.63 | 2.09 | | 2.63 |
| | | zone 2 | 2.46 | 1.88 | | 2.75 |
| | | zone 3 | 2.1 | 1.58 | | 2.32 |
| 021109g | FeMn/Y | zone 1 | 1.94 | 1.87 | | |
| | | zone 2 | 1.96 | 1.65 | | |
| | | zone 3 | 2.04 | 2.03 | | |
| 021109h | CuMnCe/Y | zone 1 | | 2.12 | 3.07 | 2.83 |
| | | zone 2 | | 2.02 | 2.85 | 2.48 |
| | | zone 3 | | 2.04 | 3.55 | 2.95 |

Preparation of high surface area ceria began by preparing ceria doped with different alkaline earth metal oxides with a pyrolysis process in powder form. The precursor salts (typically nitrates) were dissolved in de-ionized water with some fuel (glycine or ethylene glycol) added. The solution mixture was then heated up, resulting in a slow, self-propagating combustion. Most of the nitrates and organic fuel were combusted in the air. The resulting solid powder was further calcined in a furnace at 600 C for 4 h at ramp rate of 2 C/min to remove the residual carbon. The Mg and La-doped ceria has a consistent composition between the precursor solution and the final solid. One nano-ceria sample was bought from Aldrich and had an atomic ratio of Ca/Ce is 0.11/1. Although the atomic ratio of Ca/Ce was not affected by the calcination, surprisingly, there was 9.3% weight loss of this Ca—CeO2 after 4-h calcinations at 600 C of the as received from Aldrich. The packing density was increased while the H₂O-uptake pore volume was decreased for this Aldrich Ca—CeO2 sample after calcinations. This can be explained by densification. The composition of the resulting ceria powder is shown in table 4. The basic properties of the ceria powder are shown in table 5.

TABLE 4
Ceria powder used for impregnation

| | | | SEM/EDS analysis of final solid | | | | |
|---|---|---|---|---|---|---|---|
| | | Preparation | | | | | K |
| # | Sample | solution | area | Mg/Ce | La/Ce | Ca/Ce | at % |
| 031209a | Ce(Mg)O2 (I) | Ce/Mg = 1.0/0.3 | Zone | 0.32 | | | |
| | | | Large | 0.24 | | | |
| | | | crystal | | | | |
| 031209b | Ce(Mg)O2 (II) | Ce/Mg = 1.0/2.0 | Zone | 1.88 | | | |
| 031209d | Ce(La)O2(Gly) | Ce/La = 0.95/0.05 | Zone | | 0.05 | | |
| 32409 | Ce(Ca)O2 | Aldrich | Zone | | | 0.11 | |
| 32509 | Ce(Ca)O2_cal | Aldrich, | Zone | | | 0.11 | |
| | | Calcined | | | | | |

TABLE 5
Basic properties of ceria powder

| | | | Pack | Pore |
|---|---|---|---|---|
| | | BET Surface | density^{b} | Volume^{c} |
| # | Chemicals | area^{a}, m2/g | (g/cc) | (cc/g) |
| 031209a | Ce(Mg)O2(I) | 16.4 | 0.21 | 0.4 |
| 031209b | Ce(Mg)O2(II) | 65.2 | 0.30 | 0.5 |
| 031209d | Ce(La)O2(Gly) | 61.8 | 0.10 | 0.7 |
| 32409 (as | Ca_CeO2 | 205.7 | 0.50 | 0.63 |
| received) | (Aldrich) | | | |
| 32509 | Ca_CeO2_cal | 75 | 0.70 | 0.45 |

^{a}Measured by multi-point N2 adsorption.
^{b}40-100mesh particles are packed in a graduated cylinder with gentle shaking.
^{c}Measured by sorption of de-ionized water.

Preparing catalysts by impregnation of CuMn on different ceria supports, began by pre-drying the ceria powder at 120° C. for 3 hours. The ceria powder was then impregnated with the 1.0M Cu(+2)+1.0M Mn(+2) nitrate solution. The resultant materials was dried and calcinated in the furnace in air at a ramp rate of 1 C/min to 120 C, then 10 h at 120 C, then 1 C/min to 500 C, and then 10 h at 500 C. The powder was then pelletized in a press at 10,000 Lb for several minutes. Finally, the crushed pellets were passed through a sieve of about 40-100 mesh and loaded in the reactor.

Table 6 shows the catalysts prepared by impregnation of CuMn on different ceria supports.

TABLE 6

| | | Packing | | | | | | | | | |
|---|---|---|---|---|---|---|---|---|---|---|---|
| | | density | BET area | Composition, at. % | | | | | | | |
| Catalyst # | Support | g/cc | m2/g | Mn K | Mg K | La L | K K | Cu K | Ce L | Ca K | Cl K |
| 031209b | CuMn/Ce(Mg)O2(II) | 0.976 | 65.2 | 2.1% | 67.8% | | | 2.6% | 27.6% | | |
| 031209c_w | CuMn/Ce(Mg)O2(III) | 0.808 | 59.3 | 5.0% | 25.0% | | 1.3% | 4.5% | 64.2% | | |
| 031209d | CuMn/Ce(La)O2 | 0.909 | 61.8 | 4.0% | | 3.2% | | 4.6% | 88.1% | | |
| 031209f_w | CuMn/Ce(La(Ca)O2_K(II) | 0.956 | 71.1 | 2.7% | | 4.4% | 0.0% | 3.1% | 82.2% | 7.6% | |
| 32509 | CuMn/Ce(Ca)O2, | 0.920 | 91.2 | 6.1% | | | | 5.7% | 75.1% | 10.5% | 2.5% |
| | Aldrich | | | | | | | | | | |

Catalysts were then prepared by impregnating Ce(La)O₂ with different transition metal solutions by pre-drying about 3g of the ceria powder shown in table 7 (without sieving) at 120 C for 3 hours. The ceria powder was first impregnated with the clear solution. The wet sample was then dried at room temperature in the hood. The powder was then further dried and calcinated in the furnace in air, first and a ramp of 1 C/min to 120 C, then for 10 h at 120 C, then at a ramp of 1 C/min to 500 C, and then for 10 h at 500 C. The powder was then palletized in a press at 10,000 Lb for several minutes. 40-100 mesh particles of each catalyst were then separated out by a sieve for reactor loading.

TABLE 7

| | | | Packing | | | | | |
|---|---|---|---|---|---|---|---|---|
| | | Impregnation | density | Composition, at % | | | | |
| Catalyst # | Name | Solution | (g/cc) | Mn K | La L | Fe | Cu K | Ce L |
| 040309a | (FeMn)/Ce(La)O2 | 1.0M Mn (II) + | 0.818 | 8.8% | 3.4% | 8.8% | | 79.0% |
| | | 1.0 M | | | | | | |
| | | Fe(III) | | | | | | |
| 040309b | Mn/Ce(La)O2 | 2.0 M Mn (II) | 0.908 | 12.0% | 2.3% | | | 85.7% |
| 040309c | Cu/Ce(La)O2 | 2.0 M Cu (II) | 0.9539 | | 2.6% | | 16.0% | 81.4% |

Preparation of Ceria-Based Composite Catalysts with Pretreatment

The ceria support was subjected to pretreatment with ammonium nitrate and ammonium sulphate solution in sequence prior to impregation. The nitrate pretreatment is intended to protect the NO adsorption site from coverage by SO2, while the sulphate pretreatment is intended to stabilize the surface from SO2 adsorption/reaction during the SCR catalytic reaction process. The sulphate pretreatment temperature (600 C) used is much higher than the SCR reaction temperature (˜200 C). The pretreated ceria was impregnated with different metal solutions, dried and calcined 10 h at 500 C. Some of the catalyst was further reduced by H2 at 300 C after calcination.

The detailed procedures are as follows. The preparation began with log of each of the Ce(Mg)O2(II) (sample no. 031209b in tables 4, 5). The Mg—CeO2 oxide was then impregnated with NH4NO3 water solution at loading of 0.05 mmol/g solid by incipient wetness impregnation (a little excess). The impregrenated sample was then dried at 100 C for 4 h, and calcined in air for 2 h at 300 C. The resultant solid was then impregnated with a (NH4)2SO4 water solution at a loading of 0.05 mmol/g solid by incipient wetness impregnation (a little excess). The impregnated sample was then dried at 100 C for 4 h. The sample was then calcined at 600 C for 2 h in air. The observed morphology and color looked similar before and after the treatment. The pore volume was then measured with de-ionized water, showing Ce(Mg)O2(II) (031209b) of 0.6 ml/g. The sample was then impregnated with the solution mixtures, shown in table 8.

TABLE 8

| | |
|---|---|
| A | 1.0M Cu(+2) + 1.0M Mn(+2) |
| B | 1.0M Cu(+2) + 1.0M Mn(+2) + 0.0085M Pt(IV) |
| C | 2.0M Mn(+2) |
| D | 0.0085M Pt(IV) |

The sample was then pelletized, and the pellets dried at 80 C overnight and calcined for 10 h at 500° C. at a ramp rate of 2 C/min in air. The sample was then crushed and passed through a sieve to 40-100 mesh. The Pt-containing catalysts were then loaded in to the reactor tube, and reduced in a flow of H2 at 300° C. for at least 2 h at a ramp rate of 2° C./min. The composition of the different transition metals impregnated on the pretreated ceria supports is shown in table 9.

TABLE 9

| | | | At. % by SEM/EDS | | | |
|---|---|---|---|---|---|---|
| | | | Mn K | Mg K | Cu K | Ce L |
| 041409a | CuMn/ | | 3.1% | 62.5% | 3.5% | 30.8% |
| | Ce(Mg)O2(II) | | | | | |
| 041409b | CuMnPt/ | | 1.8% | 66.1% | 2.0% | 30.1% |
| | Ce(Mg)O2(II) | | | | | |
| 041409c | Mn/ | Area 1 | 6.6% | 62.5% | 0.0% | 31.0% |
| | Ce(Mg)O2(II) | Area 2 | 13.9% | 59.0% | 0.0% | 27.1% |
| 041409d | Pt/ | | 0.0% | 65.2% | 0.0% | 34.8% |
| | Ce(Mg)O2(II) | | | | | |

A sulphated-zirconia catalyst was prepared by obtaining sulfated zirconium hydroxide from Aldrich. The samples were heated at a ramp rate of 1 C/min to 660 C and held at that temperature for 6 h, then cooled down at ramp rate of 1 C/min. The observed ΔWₗₒₛₛ was 13.4313-9.2134, or 4.22 g. The BET surface area was then measured and shown as 89.85 m2/g and pore volume was measured and shown as 0.3 ml/g by DI water. Impregnation was then conducted with the solution shown in table 10.

TABLE 10

| | Solution for impreganation |
|---|---|
| 041309a | 1.0M Cu(+2) + 1.0M Mn(+2) |
| 041309b | 0.8M Mn(+2) + 1.2 M Ce(+3) |
| 041309c | 0.8M Mn(+2) + 1.2 M Ce(+3) + 0.013 M Pt (IV) |
| 041309d | 1.0M Cu(+2) + 1.0M Mn(+2) + 0.013 M Pt(IV) |

The wetted powder was left in the hood overnight. The sample was then palletized and dried at 80 C overnight and calcined for 10 h at 500° C. at a ramp rate of 2 C/min in air. The calcined pellet was then crushed and passed through a sieve to 40-100 mesh. The Pt-containing catalysts were then loaded into the reactor tube, and reduced by a flow of H2 at 300° C. for at least 2 h at a ramp rate of 2° C./min. The samples were then palletized, crushed, and passed through a sieve to 40-100 mesh.

Table 11 shows the composition of catalysts supported on sulphate-zirconia.

TABLE 11

| | | Packing | | | | |
|---|---|---|---|---|---|---|
| | Catalyst | density | Composition, at % | | | |
| | name | (g/cc) | Zr L | Mn K | Cu K | Ce L |
| 041309a | CuMn/ZrO2 | 1.1 | 91.7% | 3.3% | 4.9% | |
| 041309b | MnCe/ZrO2 | 1.28 | 95.3% | 1.9% | | 2.8% |
| 041309c | MnCePt/ZrO2 | 1.18 | 93.1% | 1.8% | | 5.1% |
| 041309d | CuMnPt/ZrO2 | 1.06 | 94.4% | 2.4% | 3.2% | |

Finally, composite catalysts were prepared by a pyrolysis method. Nitrate salts of precursor metals were dissolved into de-ionized water based on required stoichiometric ratio. Glycine as a combustion fuel was added into the solution mixture. As the solution was heated up on a hot plate, a slow self-propagating combustion occurred. Most of the nitrates and organic fuel were combusted in the air. The resulting solid powder was further calcined in a furnace at 500 C for 10 h at ramp rate of 2 C/min to remove the residual carbon. The resulting powder was sieved to 40 to 100 mesh and analyzed for elemental composition by SEM/EDS and for BET surface area by N2 adsorption.

Table 12 shows the composition and properties of the catalysts prepared by then pyrolysis method.

TABLE 12

| | | BET | | | | |
|---|---|---|---|---|---|---|
| | | Sur- | | | | |
| | | face | | | | |
| | | Area, | at % | | | |
| # | Name | m2/g | Ce | Mn | La | Mg |
| 051809c | Mn/Ce(Mg)O2 | 72 | 40.0% | 4.8% | 0.0% | 55.2% |
| | (II) | | | | | |
| 051809d | Mn0.15Ce0.8(La) | 60.6 | 85.5% | 9.8% | 4.6% | 0.0% |
| 051809e | Mn0.4Ce0.6(La) | 56.8 | 75.1% | 21.4% | 3.5% | 0.0% |

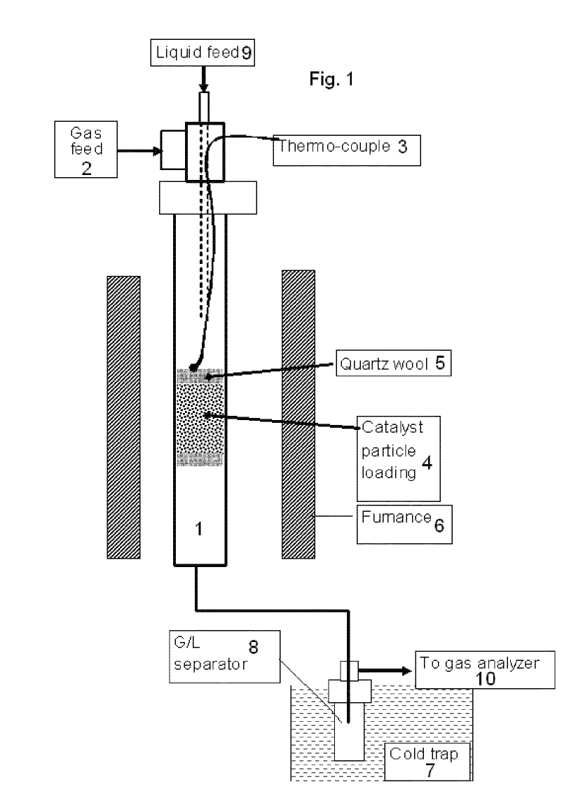

The catalysts were then tested to determine their effectiveness at selective reduction of nitrogen oxide. FIG. 1 shows a schematic of the testing system. 0.18 cc of catalyst particles at 40-100 mesh 4 is loaded in the middle of a quartz tube reactor 1 in between two quartz wool plugs 5. Surrounding the reactor 1 is a furnace 6. The feed gas stream 2 flows down through the catalyst bed, and, if necessary, a liquid feed stream 9 also flows down through the catalyst bed. A thermocouple 3 is placed on top of the catalyst bed to measure the reaction temperature. The reactor effluent is cooled down with a cold trap 7 to 4° C. to condense the water. The condensed water is knocked out in a gas/liquid drum 8 and the remaining gas is analyzed by FTIR 10. The catalytic testing is conducted at constant temperature and atmospheric pressure.

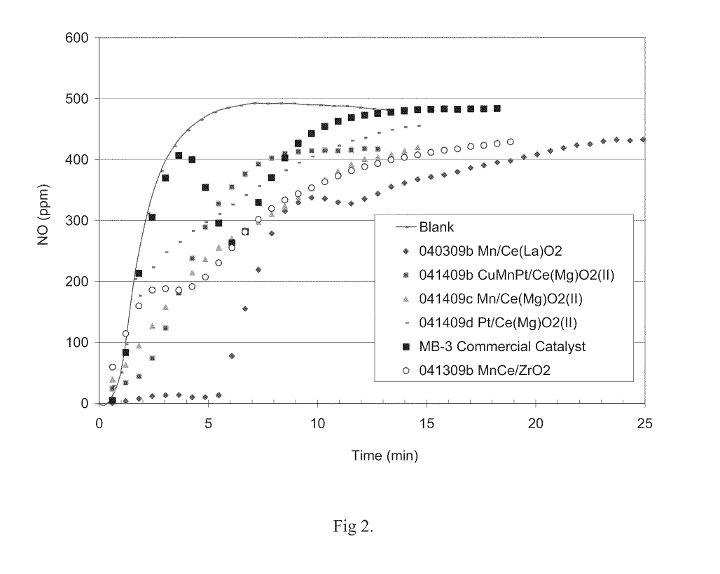

Three different catalytic process concepts were tested for each reactor loading. The first process was selective adsorption. In this test, the adsorbent bed was heated to 140 C in flowing air. When the temperature was stabilized, water vapor was introduced through a syringe pump. When the flow was stabilized, the simulated flue gas was introduced and the composition of the reactor effluent was continuously monitored. In this way, breakthrough curves were measured to assess if there was any selective NO adsorption on the adsorbent. The simulated flue gas contained about 1000 ppm of SO2, 500 ppm of NO, 4% O2, 10% CO2, 10% H2O, and balance N2. When the flue gas passed through an empty reactor tube, NO quickly emerged at the reactor effluent upon the feedgas being switched to the flue gas. When there was adsorption of NO on the catalyst, the breakthrough time of NO would be delayed. The longer the delay time was, the more adsorption capacity the catalyst possesses. FIG. 2 shows that the Mn/Ce(La)O2 catalyst showed the highest NO adsorption capacity. Under such reaction temperatures, NO adsorption is likely to be chemi-sorption rather than physic-sorption. NO may be captured on the catalyst surface as nitrate or nitrite functional groups.

The adsorption process proceeded according to the following reaction:

NO(g)+O2(g)+Catalyst surface(s)→NO3-Catalyst surface(s)+NO2-Catalyst surface(s)

The second catalytic process concept was selective reduction of NO by syn gas (CO+H2). In this process, a syngas (H2+CO mixture) was introduced into the reactor together with the flue gas at molar quantity greater than that of NO but less than the O₂ combustion. Table 13 shows typical gas compositions used in the present catalyst screening tests.

TABLE 13

Feed stream

| | NH3 SCR flue | Syngas SCR flue |
|---|---|---|
| | gas mixture Air | gas mixture Air |
| Composition, Vol | NH₃ + H₂O solution | diluted syngas |
| NO, ppm | 338.1 | 272.7 |
| SO₂, ppm | 741.3 | 597.8 |
| NH₃, ppm | 353.0 | 0.0 |
| CO₂, % | 9.8 | 7.9 |
| CO, % | 0.0 | 0.8 |
| H₂, % | 0.0 | 0.8 |
| O_{2,} % | 4.4 | 2.4 |
| H₂O, % | 9.7 | 10.0 |

The syngas SCR followed the following equations:

2NO(g)+2CO(g)→N2(g)+2CO2(g)

2NO(g)+2H2(g)→N2(g)+2H2O(g)

The third catalytic process concept was selective reduction of NO by NH3. In these tests, NH3 was introduced into the reactor together with H2O in a form of ammonium hydroxide water solution. The solution was delivered by a syringe pump (not shown) and vaporized inside the reactor. The flow rate and ammonium hydroxide solution were selected such that the molar ratio of NH3 to NO was 1:1 and water vapor molar fraction inside the reactor is about 10%. Table 13 shows the typical gas composition used in this work.

The NH3 SCR proceeded according to the following reaction.

NO(g)+0.5O2(g)+NH3(g)→N2(g)+1.5H2O(g)

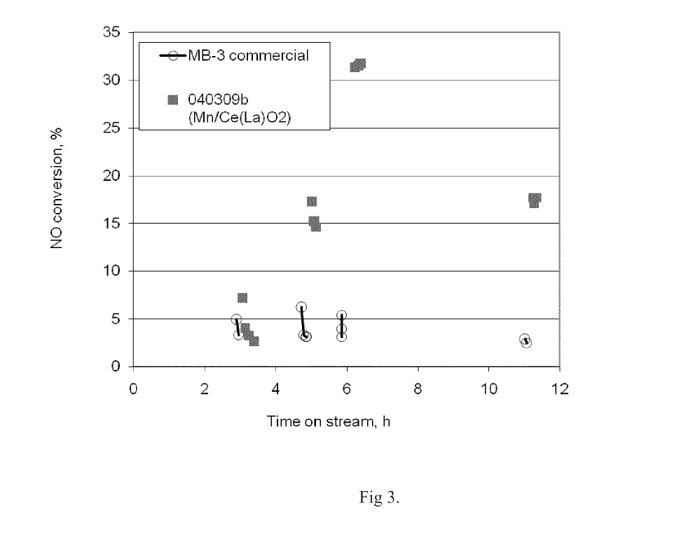

The catalyst testing results are summarized in Table 14. The gas-hourly space velocity was controlled nearly constant (35,000 v/v/h on dry gas basis). The space velocity normalized by catalyst weight differs among various catalysts because of their different packing densities. The conversion numbers in Table 14 are the average of experimental data points within first 2 hours after start of the catalytic reaction. FIG. 3 shows the variation of NO conversion with time of stream (180° C., NH3/NO=1:1, 35,000 v/v/h).

The results in table 14 clearly demonstrate the catalyst design principle of present invention. For the same transition metals, their activities vary significantly among different supporting matrix. For the same supporting matrix, the activity varies significantly among different transition metals. Notably, the Mn-ceria composite catalyst exhibits the highest activity for NH3 SCR.

Table 14 Summary of catalyst reaction testing results

| | | | | | NO conversion % | |
|---|---|---|---|---|---|---|
| | | | WHSV | Temp | Syngas | |
| Catalyst # | Catalyst name | Loading g | cc/g/h | ° C. | SCR | NH3 SCR |
| MB-3 | Commercial | 0.183 | 32,877 | 135 | 2 | 4.5 |
| MB-3 | Commercial | | | 160 | N/A | 6.7 |
| | | | | | | 5.5 (very |
| MB-3 | Commercial Catalyst | 0.175 | 34,208 | 180 | 3.5 | unstable) |
| 121508a | CuCe/ZSM-5 | 0.170 | 27,488 | 160 | 1.5 | 2.9 |
| 121508b | MnCe/ZSM-5 | 0.193 | 32,504 | 160 | 6.4 | 7.4 |
| 011609a | CuCe/ZSM-5 | 0.096 | 62,305 | 135 | 1.2 | 2.9 |
| 011209a | CuCe/Y | 0.089 | 67,568 | 180 | 1.5 | 2.2 |
| 021109a | FeCe/ZSM5 | 0.123 | 48,662 | 160 | 3 | 0 |
| 021109e | FeCe/Y | 0.123 | 48,662 | 160 | 1.8 | 0.8 |
| 021109c | FeMn/ZSM5 | 0.121 | 49,751 | 180 | 0 | 5.9 |
| 021109g | FeMn/Y | 0.098 | 61,038 | 180 | 1.3 | 2.2 |
| 021109b | FeMnCe/ZSM5 | 0.139 | 43,321 | 180 | 3.3 | 4.6 |
| 021109f | FeMnCe/Y | 0.099 | 60,852 | 180 | 0.3 | 2 |
| 021109d | CuMnCe/ZSM5 | 0.125 | 47,923 | 180 | 3.4 | 4.3 |
| 021109h | CuMnCe/Y | 0.106 | 56,444 | 180 | 0 | 2 |
| 032509 | CuMn/Ce(Ca)O2, Aldrich | 0.229 | 26,189 | 180 | 1.3 | 2.5 |
| 031209b | CuMn/Ce(Mg)O2(II) | 0.203 | 29,630 | 180 | 11.3 | 5.1 |
| 031209d | CuMn/Ce(La)O2 | 0.200 | 29,955 | 180 | 0 | 1.8 |
| 040309a | (FeMn)/Ce(La)O2 | 0.201 | 29,851 | 180 | 3.9 | 10.5 |
| 040309b | Mn/Ce(La)O2 | 0.201 | 29,851 | 180 | 7 | 39 |
| 040309c | Cu/Ce(La)O2 | 0.241 | 24,896 | 180 | 2.3 | 2.3 |
| 041409b | CuMnPt/Ce(Mg)O2(II) | 0.187 | 32,086 | 180 | 1 | 3.9 |
| 041409c | Mn/Ce(Mg)O2(II) | 0.199 | 30,090 | 180 | 9.2 | 3.6 |
| 041409d | Pt/Ce(Mg)O2(II) | 0.149 | 40,296 | 180 | 0.5 | 7 |
| 041309b | MnCe/ZrO2 | 0.270 | 22,222 | 180 | 6.2 | 11.1 |
| 011209b | MnCe/Y | 0.083 | 72,289 | 180 | 0.8 | 7.9 |
| 051809c | Mn/Ce(Mg)O2 | 0.200 | 29,955 | 180 | NA | 22 |
| 051809d | Mn/Ce(La)O2 | 0.208 | 28,846 | 180 | NA | 28 |
| 051809e | Mn/Ce(La)O2 | 0.199 | 33,189 | 180 | NA | 27 |

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Likewise, where the term “input” or “output” is used in connection with an electric device or fluid processing unit, it should be understood to comprehend singular or plural and one or more signal channels or fluid lines as appropriate in the context. Finally, all publications, patents, and patent applications cited in this specification are herein incorporated by reference to the extent not inconsistent with the present disclosure as if each were specifically and individually indicated to be incorporated by reference and set forth in its entirety herein.

1) A composite catalyst material for reduction of nitrogen oxide comprising:
a matrix material comprised of cerium oxide doped with alkaline earth metal oxides, rare earth metal oxides, and combinations thereof wherein the cerium oxide comprises more than 50 atomic percent of the matrix material,
nanoparticles comprising transition metal oxides wherein said transition metal oxides comprise less than 20 atomic percent of the composite catalyst material.

2) The composite catalyst material of claim 1 further comprising noble metals dispersed in the matrix material.

3) The composite catalyst material of claim 1 wherein the alkaline earth metal oxides, rare earth metal oxides and combinations thereof are contained within a lattice structure of the cerium oxide.

4) The composite catalyst material of claim 1 wherein the nanoparticles comprising transition metals oxides are dispersed on the cerium oxide matrix material.

5) The composite catalyst material of claim 2 wherein the noble metals are dispersed on the cerium oxide matrix material.

6) The composite catalyst material of claim 1 wherein the surface area of the cerium oxide in the matrix material is greater than 35 square meters per gram.

7) A composite catalyst material for reduction of nitrogen oxide comprising:
a matrix material comprised of cerium oxide doped with lanthanum oxide wherein the cerium oxide comprises more than 90 atomic percent of the matrix material,
nanoparticles comprising manganese oxide wherein said manganese oxide comprise less than 20 atomic percent of the composite catalyst material.

8) The composite catalyst material of claim 7 further comprising noble metals dispersed in the matrix material.

9) The composite catalyst material of claim 8 wherein the noble metals dispersed in the matrix material comprise less than 0.1 atomic percentage of the composite catalyst material.

10) The composite catalyst material of claim 7 wherein the lanthanum oxide is contained within a lattice structure of the cerium oxide.

11) The composite catalyst material of claim 7 wherein the manganese oxide is dispersed on the cerium oxide containing matrix material.

12) The composite catalyst material of claim 8 wherein the noble metals are dispersed on the cerium oxide containing matrix material.

13) The composite catalyst material of claim 7 wherein the surface area of the cerium oxide in the matrix material is greater than 35 square meters per gram.

14) A method for selectively reducing a nitrogen oxide in a gas stream containing nitrogen oxide, sulfur dioxide, steam, oxygen, and carbon dioxide comprising the steps of:
providing a composite catalyst material having a matrix material comprised of cerium oxide doped with alkaline earth metal oxides, rare earth metal oxides, and combinations thereof wherein the cerium oxide comprises more than 50 atomic percent of the matrix material, nanoparticles comprising transition metal oxides wherein said transition metal oxides comprise less than 20 atomic percent of the composite catalyst material,
contacting the nitrogen oxide in the gas stream containing nitrogen oxide, sulfur dioxide, steam, oxygen, and carbon dioxide to the composite catalyst material at a temperature below 300 C, and
reducing the nitrogen oxide to nitrogen gas.

15) The method of claim 14 further comprising the step of introducing the gas stream containing nitrogen to a reducing gas prior to the step of contacting the nitrogen oxide in the gas stream to the composite catalyst material at a temperature below 300 C.

16) The method of claim 15 wherein the reducing gas is selected from the group comprising ammonia, urea, carbon monoxide, hydrogen, hydrocarbons, and combinations thereof.
